(19) United States
(12) Patent Application Publication
(10) Pub. No.: US 2025/0103340 A1
(43) Pub. Date: Mar. 27, 2025

(54) SYSTEMS AND METHODS FOR RESYNCHRONIZATION AT EXECUTION TIME

(71) Applicant: Advanced Micro Devices, Inc., Santa Clara, CA (US)

(72) Inventors: Upamanyu Banerjee, Santa Clara, CA (US); Arun A. Nair, Santa Clara, CA (US)

(73) Assignee: Advanced Micro Devices, Inc., Santa Clara, CA (US)

(21) Appl. No.: 18/475,507

(22) Filed: Sep. 27, 2023

(51) Int. Cl. G06F 9/30

(52) U.S. Cl. CPC G06F 9/30185; G06F 9/30058; G06F 9/30134

(57) ABSTRACT

A computer-implemented method for resynchronization at execution time can include detecting, by at least one processor and during an execution time of an instruction, a resynchronization. The method can additionally include regenerating, by the at least one processor and in response to the detection, an instruction pointer. The method can also include performing, by the at least one processor and during the execution time of the instruction, the resynchronization by using the regenerated instruction pointer. Various other methods and systems are also disclosed.

### BACKGROUND

Modern central processing units (CPUs) engage in speculative execution which may ultimately be incorrect. Such speculative execution includes, but is not limited to, memory order speculation. When such mis-speculation is detected, a processor is required to undo the incorrect results thus generated by flushing the offending instructions, re-fetching, and re-executing them. This process is referred to herein as a resynchronization event.

Scheduling processes for synchronization can employ a reorder buffer (e.g., a circular buffer) that can be implemented as an array and/or vector that allows recording of results against instructions as they complete out of order. Terminology referring to a reorder buffer can vary across systems. For example, the term “retire queue” can be used for a reorder buffer that uses retire instructions in order for out of order machines.

Speculative execution is an optimization technique in which a computer system can perform a task that may not be needed. The task can be performed before it is known whether it is actually needed so as to prevent a delay that would be incurred by performing the task later. One type of speculative execution can be a speculative resynchronization procedure.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example system for resynchronization at execution time.

FIG. 2 is a block diagram of an additional example system for resynchronization at execution time.

FIG. 3 is a flow diagram of an example method for resynchronization at execution time.

FIG. 4 is a block diagram of an example system for resynchronization at execution time.

FIG. 5 is a block diagram of a first portion of an example system for resynchronization at execution time.

FIG. 6 is a block diagram of a second portion of an example system for resynchronization at execution time.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to resynchronization at execution time. Resynchronization procedures incur significant performance penalties. Performing speculative resynchronization procedures during execution of operations, as opposed to waiting until retirement of the operations, can improve performance, and this improvement can increase with increased depth of a retire queue. In order to perform the speculative resynchronization, information can be provided to redirect the front end of the processor or CPU. Potential techniques for providing this information during execution time can include sending the information to the scheduler for every operation that may resynchronize and/or maintaining a table of the information for every dispatched operation. However, these potential techniques can also be expensive in terms of system resources (e.g., system power, data storage, messaging traffic, etc.).

The systems and methods disclosed herein can perform resynchronization at execution time in a less costly manner than other potential techniques. For example, by detecting a resynchronization during an execution time of an instruction, regenerating an instruction pointer in response to the detection, and performing the resynchronization using the regenerated instruction pointer, the disclosed systems and methods can avoid delay with reduced consumption of system resources compared to the potential techniques mentioned above. For example, the disclosed systems and methods can avoid sending the information to the scheduler for every operation that may resynchronize, thus reducing messaging traffic and consequent power consumption. Also, the disclosed systems and methods can avoid maintaining a table of the information for every dispatched operation, thus reducing data storage, write operations, consequent power consumption, and additional dispatch stalls that can occur if the table becomes large. Reducing resynchronization penalty in the disclosed manner can further open avenues for more aggressive speculation, such as memory order speculation.

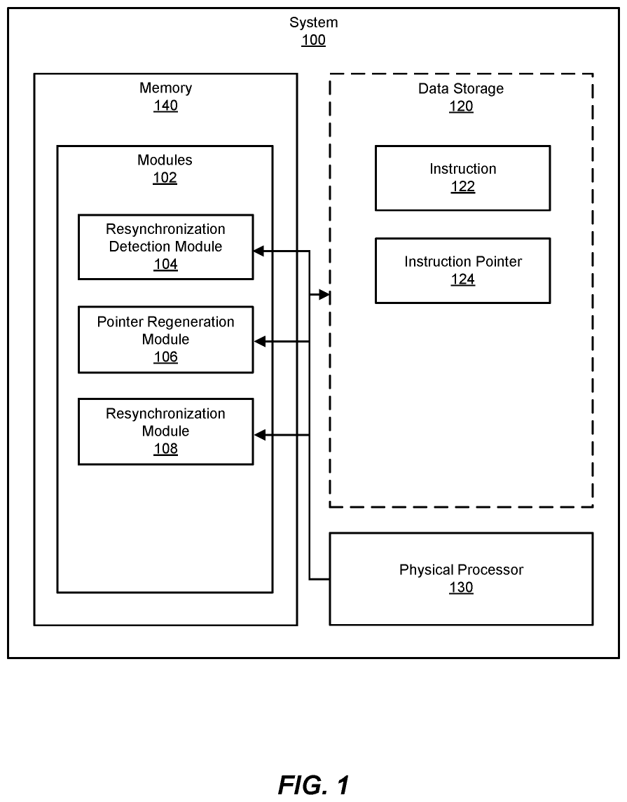

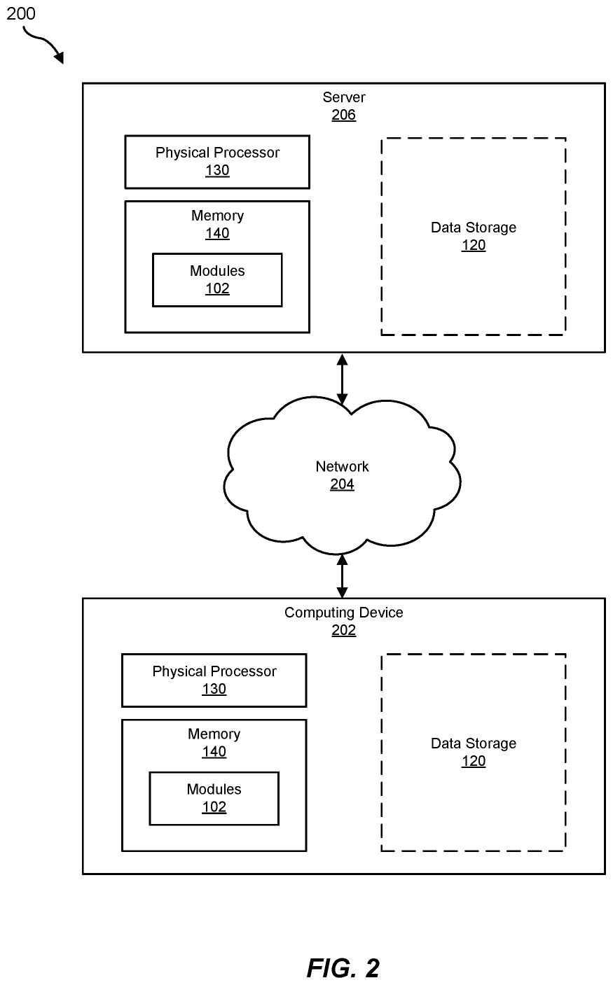

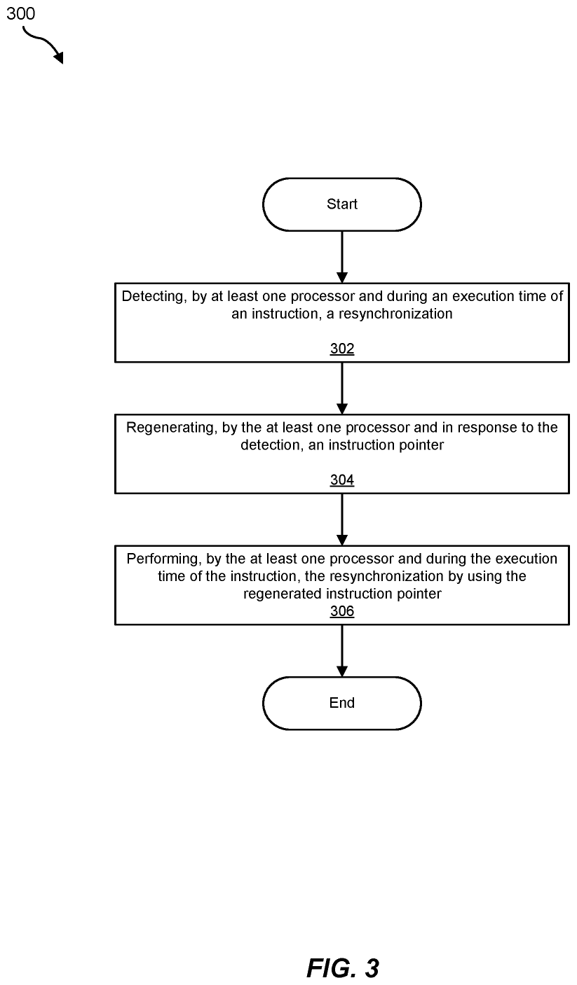

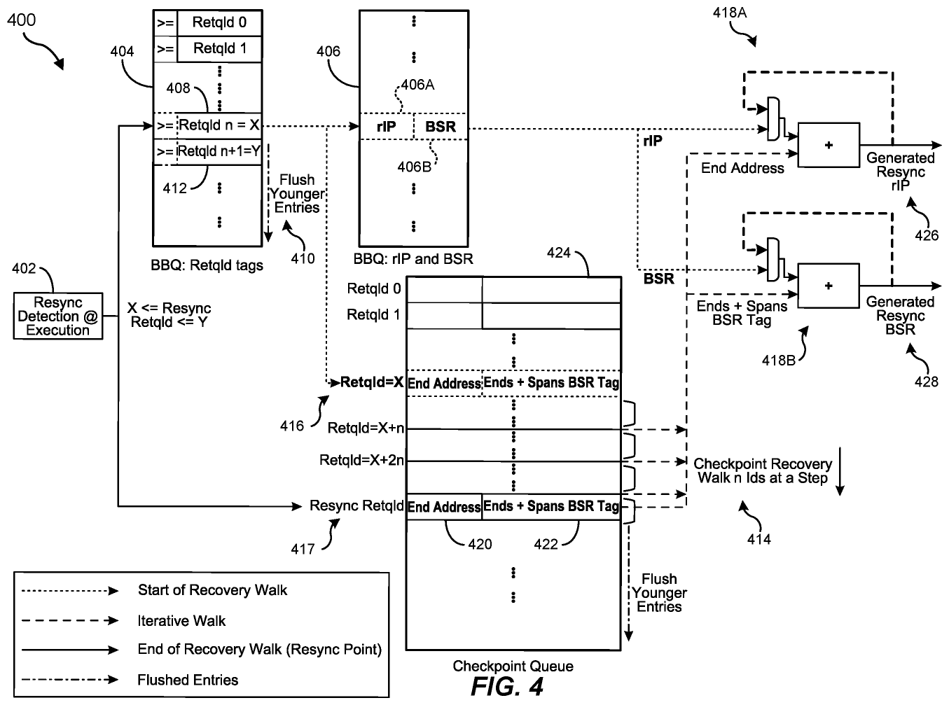

The following will provide, with reference to FIGS. 1-2, detailed descriptions of example systems for resynchronization at execution time. Detailed descriptions of corresponding computer-implemented methods will also be provided in connection with FIG. 3. In addition, detailed descriptions of example systems for resynchronization at execution time will be provided in connection with FIGS. 4-6.

In one example, a computing device can include resynchronization detection circuitry configured to detect, during an execution time of an instruction, a resynchronization, pointer regeneration circuitry configured to regenerate, in response to the detection, an instruction pointer, and resynchronization circuitry configured to perform, during the execution time of the instruction, the resynchronization by using the regenerated instruction pointer.

Another example can include the previously described example computing device, wherein the pointer regeneration circuitry is configured to regenerate the instruction pointer at least in part by walking a retire queue while incrementally regenerating the instruction pointer and a branch shift register identification tag for the instruction.

Another example can include any of the previously described example computing devices, wherein the pointer regeneration circuitry is configured to walk the retire queue at least in part by walking the retire queue between a last taken branch and a resynchronization pointer while incrementally regenerating the instruction pointer and the branch shift register identification tag using an end address of the instruction and one or more delta bits that track the branch shift register identification tag, and the resynchronization circuitry is configured to perform the resynchronization at an end of a walk of the retire queue by signaling, a speculative resynchronization and driving the regenerated instruction pointer through a redirect bus to a front end.

Another example can include any of the previously described example computing devices, wherein the pointer regeneration circuitry is configured to start a walk of the retire queue by reading, from a branch buffer queue of the retire queue, the instruction pointer and the branch shift register identification tag of a youngest taken branch older than the instruction.

Another example can include any of the previously described example computing devices, wherein the pointer regeneration circuitry is configured to start a walk of the retire queue by detecting that a branch buffer queue of the retire queue is empty and using a retired instruction pointer and branch shift register identification tag in response to the detection that the branch buffer queue is empty.

Another example can include any of the previously described example computing devices, wherein the pointer regeneration circuitry is configured to walk the retire queue at least in part by walking the retire queue between a nearest checkpoint and a resynchronization pointer while incrementally regenerating the instruction pointer and the branch shift register identification tag for sequential instructions using an end address of the instruction and one or more delta bits that track the branch shift register identification tag in a checkpoint queue of the retire queue and, for each taken branch encountered during a walk of the retire queue, performing a lookup, starting with a branch buffer queue identity read from a checkpoint array, of a branch buffer queue of the retire queue, and the resynchronization circuitry is configured to perform the resynchronization at an end of a walk of the retire queue by signaling, a speculative resynchronization and driving the regenerated instruction pointer through a redirect bus to a front end.

Another example can include any of the previously described example computing devices, further including dispatch map recovery circuitry configured to stall dispatch in response to the detection of the resynchronization and perform a recovery walk for a dispatch map in parallel with the walk of the retire queue.

In one example, a system can include at least one physical processor and physical memory that includes computer-executable instructions that, when executed by the physical processor, cause the physical processor to detect, during an execution time of an instruction, a resynchronization, regenerate, in response to the detection, an instruction pointer, and perform, during the execution time of the instruction, the resynchronization by using the regenerated instruction pointer.

Another example can be the previously described example system, wherein the computer-executable instructions cause the physical processor to regenerate the instruction pointer at least in part by walking a retire queue while incrementally regenerating the instruction pointer and a branch shift register identification tag for the instruction.

Another example can be any of the previously described example systems, wherein the computer-executable instructions cause the physical processor to walk the retire queue at least in part by walking the retire queue between a last taken branch and a resynchronization pointer while incrementally regenerating the instruction pointer and the branch shift register identification tag using an end address of the instruction and one or more delta bits that track the branch shift register identification tag, and perform the resynchronization at an end of a walk of the retire queue by signaling, a speculative resynchronization and driving the regenerated instruction pointer through a redirect bus to a front end.

Another example can be any of the previously described example systems, wherein the computer-executable instructions cause the physical processor to start a walk of the retire queue by reading, from a branch buffer queue of the retire queue, the instruction pointer and the branch shift register identification tag of a youngest taken branch older than the instruction.

Another example can be any of the previously described example systems, wherein the computer-executable instructions cause the physical processor to start a walk of the retire queue by detecting that a branch buffer queue of the retire queue is empty and using a retired instruction pointer and branch shift register identification tag in response to the detection that the branch buffer queue is empty.

Another example can be any of the previously described example systems, wherein the computer-executable instructions cause the physical processor to walk the retire queue at least in part by walking the retire queue between a nearest checkpoint and a resynchronization pointer while incrementally regenerating the instruction pointer and the branch shift register identification tag for sequential instructions using an end address of the instruction and one or more delta bits that track the branch shift register identification tag in a checkpoint queue of the retire queue and, for each taken branch encountered during a walk of the retire queue, performing a lookup, starting with a branch buffer queue identity read from a checkpoint array, of a branch buffer queue of the retire queue, and perform the resynchronization at an end of a walk of the retire queue by signaling, a speculative resynchronization and driving the regenerated instruction pointer through a redirect bus to a front end.

Another example can be any of the previously described example systems, wherein the computer-executable instructions further cause the physical processor to stall dispatch in response to the detection of the resynchronization and perform a recovery walk for a dispatch map in parallel with the walk of the retire queue.

In one example, a computer-implemented method can include detecting, by at least one processor and during an execution time of an instruction, a resynchronization, regenerating, by the at least one processor and in response to the detection, an instruction pointer, and performing, by the at least one processor and during the execution time of the instruction, the resynchronization by using the regenerated instruction pointer.

Another example can be the previously describe example computer-implemented method, wherein regenerating the instruction pointer includes walking a retire queue while incrementally regenerating the instruction pointer and a branch shift register identification tag for the instruction.

Another example can be any of the previously describe example computer-implemented methods, wherein walking the retire queue includes walking the retire queue between a last taken branch and a resynchronization pointer while incrementally regenerating the instruction pointer and the branch shift register identification tag using an end address of the instruction and one or more delta bits that track the branch shift register identification tag, and performing the resynchronization occurs at an end of a walk of the retire queue and includes signaling a speculative resynchronization and driving the regenerated instruction pointer through a redirect bus to a front end.

Another example can be any of the previously describe example computer-implemented methods, wherein incrementally regenerating the instruction pointer and the branch shift register identification tag includes starting a walk of the retire queue by reading, from a branch buffer queue of the retire queue, the instruction pointer and the branch shift register identification tag of a youngest taken branch older than the instruction.

Another example can be any of the previously describe example computer-implemented methods, wherein incrementally regenerating the instruction pointer and the branch shift register identification tag includes starting a walk of the retire queue by detecting that a branch buffer queue of the retire queue is empty and using a retired instruction pointer and branch shift register identification tag in response to the detection that the branch buffer queue is empty.

Another example can be any of the previously describe example computer-implemented methods, wherein walking the retire queue includes walking the retire queue between a nearest checkpoint and a resynchronization pointer while incrementally regenerating the instruction pointer and the branch shift register identification tag for sequential instructions using an end address of the instruction and one or more delta bits that track the branch shift register identification tag in a checkpoint queue of the retire queue and, for each taken branch encountered during a walk of the retire queue, performing a lookup, starting with a branch buffer queue identity read from a checkpoint array, of a branch buffer queue of the retire queue, and performing the resynchronization occurs at an end of a walk of the retire queue and includes signaling a speculative resynchronization and driving the regenerated instruction pointer through a redirect bus to a front end.

FIG. 1 is a block diagram of an example system 100 for resynchronization at execution time. As illustrated in this figure, example system 100 can include one or more modules 102 for performing one or more tasks. As will be explained in greater detail below, modules 102 can include a resynchronization detection module 104, a pointer regeneration module 106, and a resynchronization module 108. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as the devices illustrated in FIG. 2 (e.g., computing device 202 and/or server 206). One or more of modules 102 in FIG. 1 can also represent all or portions of one or more special-purpose computers configured to perform one or more tasks. For example, one or more of modules 102 can be implemented as analog and/or digital circuitry in a processor, such as a CPU.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory. In some implementations, memory 140 can be located (e.g., partially or entirely) outside of a physical processor (e.g., CPU) in a separate die/chip (e.g., DRAM, disk, SSD, etc, etc.). In other implementations, memory 140 can be located (e.g., partially or entirely) in a physical processor (e.g., CPU), and can be implemented using various circuit elements (e.g., analog and/or digital (e.g., flip-flops, latches, etc.)). In this context, memory 140 can logically be a part of a retire queue unit/cluster, and an instruction pointer 124 can also be located inside the physical processor. Instruction pointer 124 can point to an instruction residing in memory 140 (e.g., DRAM).

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate resynchronization at execution time. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The term “modules,” as used herein, can generally refer to one or more functional components of a computing device. For example, and without limitation, a module or modules can correspond to hardware, software, or combinations thereof. In turn, hardware can correspond to analog circuitry, digital circuitry, communication media, or combinations thereof. In some implementations, the modules can be implemented as microcode (e.g., a collection of instructions running on a micro-processor, digital and/or analog circuitry, etc.) and/or one or more firmware in a graphics processing unit. For example, a module can correspond to a GPU, a trusted micro-processor of a GPU, and/or a portion thereof (e.g., circuitry (e.g., one or more device features sets and/or firmware) of a trusted micro-processor). Alternatively or additionally, one or more of modules 102 can be located in a CPU, such as physical processor 130.

As illustrated in FIG. 1, example system 100 can also include one or more instances of stored data, such as data storage 120. Data storage 120 generally represents any type or form of stored data, however stored (e.g., signal line transmissions, bit registers, flip flops, software in rewritable memory, configurable hardware states, combinations thereof, etc.). In one example, data storage 120 includes databases, spreadsheets, tables, lists, matrices, trees, or any other type of data structure. Examples of data storage include, without limitation, instruction 122 and instruction pointer 124.

Example system 100 in FIG. 1 can be implemented in a variety of ways. For example, all or a portion of example system 100 can represent portions of example system 200 in FIG. 2. As shown in FIG. 2, system 200 can include a computing device 202 in communication with a server 206 via a network 204. In one example, all or a portion of the functionality of modules 102 can be performed by computing device 202, server 206, and/or any other suitable computing system. As will be described in greater detail below, one or more of modules 102 from FIG. 1 can, when executed by at least one processor of computing device 202 and/or server 206, enable computing device 202 and/or server 206 to perform resynchronization at execution time.

Computing device 202 generally represents any type or form of computing device capable of reading computer-executable instructions. In some implementations, computing device 202 can be and/or include one or more graphics processing units having a chiplet processor connected by a switch fabric. Additional examples of computing device 202 include, without limitation, platforms such as laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device. Alternatively or additionally, computing device 202 can correspond to a device operating within such a platform.

Server 206 generally represents any type or form of platform that provides cloud service (e.g., cloud gaming server) that includes one or more computing devices 202. In some implementations, server 206 can be and/or include a cloud service (e.g., cloud gaming server) that includes one or more graphics processing units having a chiplet processor connected by a switch fabric. Additional examples of server 206 include, without limitation, storage servers, database servers, application servers, and/or web servers configured to run certain software applications and/or provide various storage, database, and/or web services. Although illustrated as a single entity in FIG. 2, server 206 can include and/or represent a plurality of servers that work and/or operate in conjunction with one another.

Network 204 generally represents any medium or architecture capable of facilitating communication or data transfer. In one example, network 204 can facilitate communication between computing device 202 and server 206. In this example, network 204 can facilitate communication or data transfer using wireless and/or wired connections. Examples of network 204 include, without limitation, a Peripheral Component Interconnect express (PICe) bus, a Nonvolatile memory express (Nvme) bus, a Local Area Network (LAN), a Personal Area Network (PAN), Power Line Communications (PLC), portions of one or more of the same, variations or combinations of one or more of the same, or any other suitable network that enables the computing device 202 to perform data communication with other components on the platform of server 206. In other examples, network 204 can be an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1 and/or system 200 in FIG. 2. Conversely, all of the components and devices illustrated in FIGS. 1 and 2 need not be present to practice the implementations described and/or illustrated herein. The devices and subsystems referenced above can also be interconnected in different ways from that shown in FIG. 2. Systems 100 and 200 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, can generally refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 is a flow diagram of an example computer-implemented method 300 for resynchronization at execution time. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

The term “computer-implemented method,” as used herein, can generally refer to a method performed by hardware or a combination of hardware and software. For example, hardware can correspond to analog circuitry, digital circuitry, communication media, or combinations thereof. In some implementations, hardware can correspond to digital and/or analog circuitry arranged to carry out one or more portions of the computer-implemented method. In some implementations, hardware can correspond to physical processor 130 of FIG. 1. Additionally, software can correspond to software applications or programs that, when executed by the hardware, can cause the hardware to perform one or more tasks that carry out one or more portions of the computer-implemented method. In some implementations, software can correspond to one or more of modules 102 stored in memory 140 of FIG. 1.

As illustrated in FIG. 3, at step 302 one or more of the systems described herein can detect a resynchronization. For example, resynchronization detection module 104 can, as part of computing device 202 in FIG. 2, detect, by at least one processor and during an execution time of an instruction, a resynchronization.

The term “resynchronization,” as used herein, can generally refer to performance of process synchronization at a point in execution of a process occurring after initial synchronization. For example, and without limitation, resynchronization can involve identifying a point in a process at which synchronization was maintained (e.g., a last instruction successfully executed without a mis-speculation (miss) in memory order), returning to that point in the process, flushing reorder buffer entries subsequent to that point, and continuing execution of the process from that point.

The term “execution time,” as used herein, can generally refer to the time a computer spends working on a task. For example, and without limitation, execution time can be distinguished from compile time, load time, and retire time, with execution time occurring between load time and retire time. In this context, “execution” can refer to a pipeline stage in which the instruction is executed to obtain a result in a register, memory address, i/o, etc.

The term “instruction,” as used herein, can generally refer to an order given to a computer by a computer program. For example, and without limitation, an instruction can be included in machine language instructions that a particular processor understands and executes. In this context, a process can correspond to a set of machine language instructions.

The systems described herein can perform step 302 in a variety of ways. In one example, resynchronization detection module 104 can, as part of computing device 202 in FIG. 2, detect a speculative synchronization based on miss speculation in memory ordering. In some implementations, miss speculation in memory ordering can include incorrect memory renaming. Additionally or alternatively, miss speculation in memory reordering can include incorrect store-to-load forwarding. In some implementations, miss speculation can be performed more aggressively (e.g., adjusted speculation weights, thresholds, etc.) due to the reduced resynchronization penalty provided by the disclosed systems and methods.

At step 304 one or more of the systems described herein can regenerate a pointer. For example, pointer regeneration module 106 can, as part of computing device 202 in FIG. 2, regenerate, by the at least one processor and in response to the detection, an instruction pointer.

The term “instruction pointer,” as used herein, can generally refer to a process register that indicates where a computer is in its program sequence. For example, and without limitation, an instruction pointer can correspond to a program counter, an instruction address register, an instruction counter, a retire pointer, etc. Stated differently, an instruction pointer can correspond to a memory address of a next instruction to execute in a program's code segment. In x86 ISA, the instruction pointer can be called a register extension (REX) instruction pointer (rIP) in sixty-four bit mode and an instruction pointer (IP) for all other modes. An instruction pointer can be incremented after fetching an instruction such that a current instruction pointer may indicate a process register that is subsequent to a resynchronization pointer. In this context, “regenerating” an instruction pointer can entail resetting the instruction pointer to a known process register (e.g., a last taken branch of a branch buffer queue (BBQ), a nearest checkpoint of a checkpoint array, etc.) that precedes the resynchronization pointer and incrementing the reset instruction pointer until reaching the resynchronization pointer.

The systems described herein can perform step 304 in a variety of ways. In one example, pointer regeneration module 106 can, as part of computing device 202 in FIG. 2, regenerate the instruction pointer by walking a retire queue while incrementally regenerating the instruction pointer and a branch shift register identification tag for the instruction. In some implementations, walking the retire queue can include walking the retire queue between a last taken branch and a resynchronization pointer while incrementally regenerating the instruction pointer and the branch shift register identification tag using an end address of the instruction and one or more delta bits that track the branch shift register identification tag. In some of these implementations, incrementally regenerating the instruction pointer and the branch shift register identification tag can include starting a walk of the retire queue by reading, from a branch buffer queue of the retire queue, the instruction pointer and the branch shift register identification tag of a youngest taken branch older than the instruction. Alternatively or additionally, incrementally regenerating the instruction pointer and the branch shift register identification tag can include starting a walk of the retire queue by detecting that a branch buffer queue of the retire queue is empty and using a retired instruction pointer and branch shift register identification tag in response to the detection that the branch buffer queue is empty.

The term “retire queue (RETQ),” as used herein, can generally refer to a reorder buffer. For example, and without limitation, a retire queue can be used to retire instructions in order for out of order machines. In this context, a “RETQid” can correspond to an identification tag assigned to a retire queue entry.

The term “branch buffer queue,” as used herein, can generally refer to a structure that stores target addresses of taken branches of a process. For example, and without limitation, a BBQ can store a target address corresponding to an instruction pointer of an instruction executed immediately after the taken branch in program order. The BBQ can be implemented as part of the retire queue. In this context, a BBQ tag (BBQid) can refer to an identification tag assigned to a BBQ entry.

The term “branch shift register (BSR),” as used herein, can generally refer to a structure that stores branch prediction information in a front end of the machine. For example, and without limitation, after a redirect, the front end (e.g., mainly a branch predictor) needs to know from which BSR entry the redirect comes so that it can flush younger entries of the BSR and continue predicting use of a next BSR entry.

The term “branch shift register identification tag (BSRid),” as used herein, can generally refer to delta information. For example, and without limitation, BSR identification tags can incrementally be allocated to a set of instructions and, hence, can be regenerated in a later pipeline in order to capture a delta (e.g., change, difference, etc.) per instruction. In various implementations, delta bits can be located in various types of data structures (e.g., checkpoint queue) and can track the branch shift register identification tag. For example, the delta bits can correspond to offsets from a previous BSR identification tag (e.g., BSR index) that can be added to a previous BSR identification tag to yield another BSR identification tag. The delta information can correspond to ends and spans bits that express these deltas and can be stored in the retire queue per instruction, thus enabling regeneration of the BSR identification tag during retire time of an instruction. Such regeneration can also be performed during a resynchronization recovery walk according to the systems and methods disclosed herein. In some examples, and without limitation, the ends and spans bits can correspond to two bits that indicate whether a corresponding instruction ends a BSR tag, spans a BSR tag, or both. In this context, a “recovery walk” can correspond to a process that starts from a checkpoint and ends at a recovery point and that incrementally recovers machine states with the help of other retire queue structures (e.g., checkpoint queue, BBQ, etc.).

The term “end address,” as used herein,” can generally refer to a number of bytes. For example, and without limitation, an end address can correspond to a number of bytes required to encode a variable length instruction (e.g., x86 instructions).

In other implementations, walking the retire queue can include walking the retire queue between a nearest checkpoint and a resynchronization pointer. This walk can entail incrementally regenerating the instruction pointer and the branch shift register identification tag for sequential instructions using an end address of the instruction and one or more delta bits in a checkpoint queue of the retire queue. For each taken branch encountered during a walk of the retire queue, a lookup can be performed, starting with a branch buffer queue identity read from a checkpoint array, of a branch buffer queue of the retire queue. Walking the retire queue between a nearest checkpoint and a resynchronization pointer can result in a walk that is a same length as a recovery walk for a dispatch map. Accordingly, these implementations can further include stalling dispatch in response to the detection of the resynchronization and performing a recovery walk for a dispatch map in parallel with the walk of the retire queue.

The term “checkpoint,” as used herein, can generally refer to a record of a machine state. For example, and without limitation, checkpoints can correspond to periodic snapshots of machine states that can be used during a redirect as a reference point for recovering a machine back to a state immediately before the redirect. These checkpoints can be used to improve performance by reducing a redirect penalty. In this context, a “checkpoint array” can correspond to an array of checkpoints taken on periodic intervals of dispatched instructions. In this context, a “resync redirect” can correspond to an instruction that can return control by asking a front end to reflow all instructions starting from a specified instruction and can flush all pipelines and structures holding speculative instructions. In contrast, a “branch redirect” can correspond to a branch instruction that transfers control to a different part of program code and flushes all pipelines and structures holding younger instructions in a mis-speculated part of the code.

The term “checkpoint queue,” as used herein, can generally refer to a structure that stores changes made in a machine state per instruction. For example, and without limitation, a checkpoint queue can be used in conjunction with a checkpoint array during a recovery walk process carried out according to the systems and methods disclosed herein. The checkpoint queue can be one of many structures included in the retire queue.

The term “dispatch,” as used herein, can generally refer to a pipeline stage. For example, and without limitation, dispatch can refer to a pipeline stage in which instructions flow from a front end of a machine (e.g., fetch and/or decode) to a back end (e.g., out of order execution, memory operation, and/or retire). In this context, a “dispatch map,” can correspond to a register aliasing table (RAT) used to hold register renaming mappings.

Compared to implementations that walk the retire queue between a nearest checkpoint and a resynchronization pointer, implementations that walk the retire queue between a last taken branch and a resynchronization pointer can result in a shorter walk because taken branches are common. For these implementations, an additional BBQ read port and retire queue identification tag (RETQid) content addressable memories (CAMs) can be activated during resynchronization without consuming significant power. Such CAMs may already exist in some systems for flush handling of the BBQ.

The term “content addressable memory,” as used herein, can generally refer to a comparator. For example, and without limitation, content addressable memory can compare an input search tag against a table of stored tags and return data associated with a matching entry of the table.

Implementations that walk the retire queue between a nearest checkpoint and a resynchronization pointer are an alternative that can be exercised when CAMs for flush handling of the branch buffer queue are not included and/or when performing a recovery walk for a dispatch map in parallel with the walk of the retire queue is desirable. These implementations can avoid RETQid CAMS at the expense of additional storage in a checkpoint array and a longer walk compared to implementations that walk the retire queue between a last taken branch and a resynchronization pointer.

At step 306 one or more of the systems described herein can perform resynchronization. For example, resynchronization module 108 can, as part of computing device 202 in FIG. 2, perform, by the at least one processor and during the execution time of the instruction, the resynchronization by using the regenerated instruction pointer.

The systems described herein can perform step 306 in a variety of ways. In one example, resynchronization module 108 can, as part of computing device 202 in FIG. 2, perform the resynchronization at an end of a walk of the retire queue by signaling a speculative resynchronization and driving the regenerated instruction pointer through a redirect bus to a front end. This procedure can be employed with implementations that walk the retire queue between a last taken branch and a resynchronization pointer and with implementations that walk the retire queue between a nearest checkpoint and a resynchronization pointer.

FIG. 4 illustrates an example system 400 for resynchronization at execution time. For example, system 400 can walk a retire queue between a last taken branch and a resynchronization pointer. When a resynchronization detection 402 occurs at execution time of an instruction, system 400 can read from BBQ 404 a rIP+BSR 406 of the last (i.e., youngest) taken branch 408 older than the instruction. In some implementations, system 400 can read this information by indexing through a BBQid. In other implementations, system 400 can read this information by comparing a RETQid of the instruction with every entry in BBQ 404. This procedure can be performed using an additional resynchronization read port to obtain the rIP+BSR 406 tag. As shown at 410, all younger BBQ 404 entries 412 can be flushed at this time. In the event that BBQ 404 is empty (i.e., the last retired instruction is nearer than the last taken branch), system 400 can use a retired rIP+BSR instead by substituting it for the rIP+BSR 406 of the youngest taken branch older than the instruction. Accordingly, the phrase “instruction pointer of the youngest taken branch older than the instruction,” as used herein, can also refer to a retired instruction pointer.

System 400 can use the rIP+BSR 406 of the youngest taken branch older than the instruction to perform a walk 414 of a RETQ from the last taken branch 416 (e.g., corresponding to last taken branch 408) to a resynchronization pointer 417 provided by the resynchronization detection 402 while incrementally regenerating the rIP+BSR 406 using an end address 420 and ends/spans BSR tag 422 information. End address 420 and ends/spans BSR tag 422 can reside in a checkpoint queue 424 or any other RETQ structure that has flush read ports. System 400 can provide rIP 406A of last taken branch 408 and end address 420 of walked checkpoint queue 424 entries to adder 418A, which can be configured to increment recursively rIP 406A based on the end address 420. System 400 can also provide BSR 406B of last taken branch 408 and ends/spans BSR tag 422 of walked checkpoint queue 424 entries to adder 418B, which can be configured to increment recursively BSR 406B based on the ends/spans BSR tag 422. The walk 414 can be complete when system 400 reaches resynchronization pointer 417, at which point the outputs of adder 418A and adder 418B can respectively correspond to a regenerated rIP 426 and a regenerated BSR 428. At the end of walk 414, system 400 can signal a speculative resynchronization and drive the regenerated rIP 426 and regenerated BSR 428 through a redirect bus to a front end of the machine. In the event that the resynchronization becomes nonspeculative during walk 414, system 400 can kill walk 414. Similarly, system 400 can kill walk 414 on an older flush (e.g., an older branch redirect or an older speculative resynchronization).

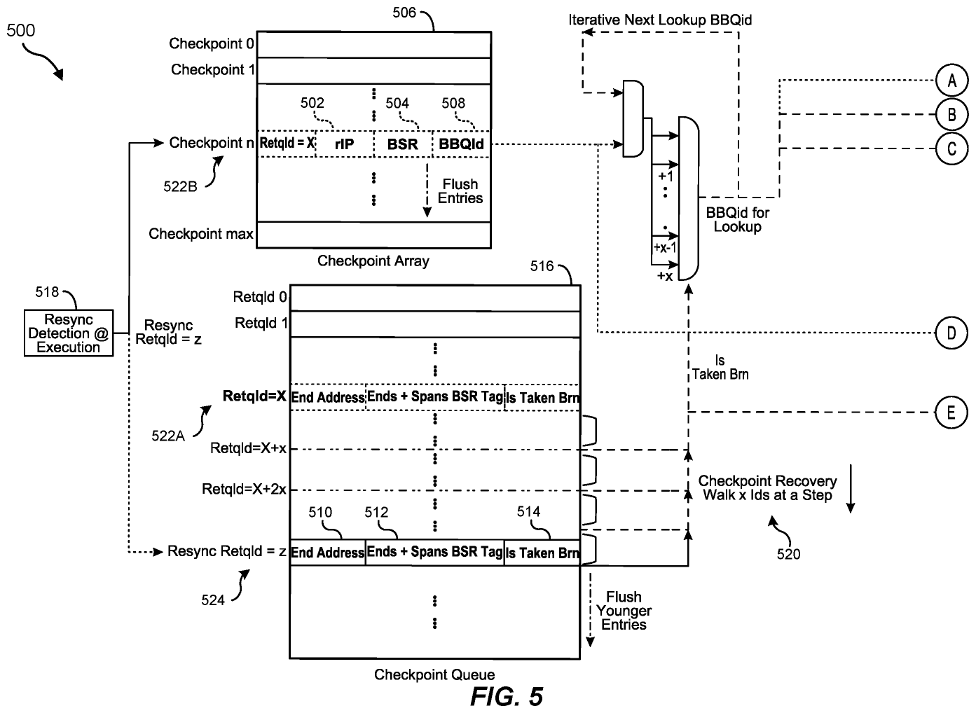

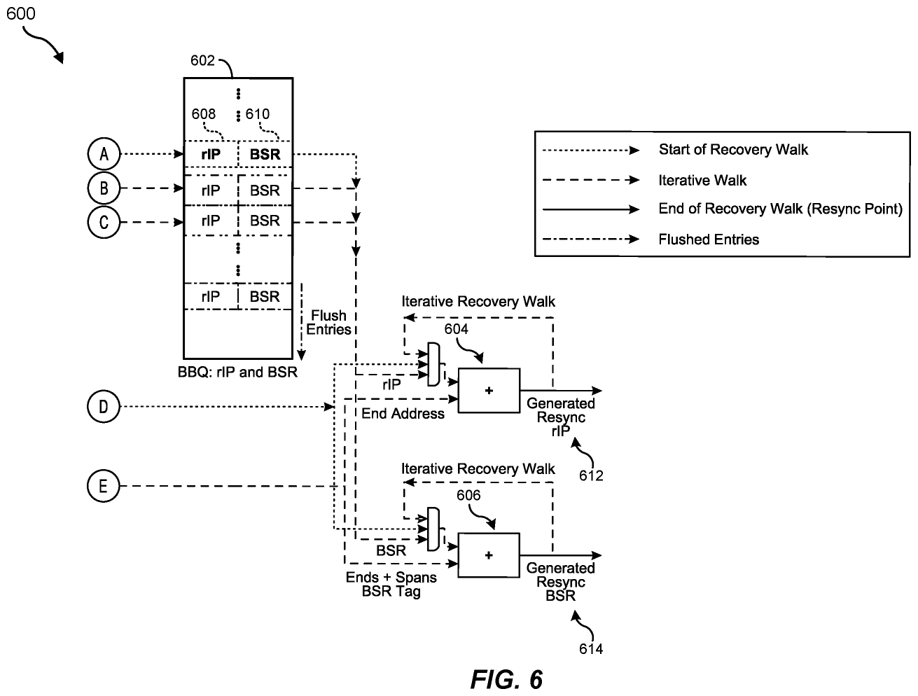

FIGS. 5 and 6 respectively illustrate a first portion 500 and a second portion 600 of an example system for resynchronization at execution time. For example, first portion 500 can walk a retire queue between a nearest checkpoint and a resynchronization pointer. First portion 500 and second portion 600 of the example system shown in FIGS. 5 and 6 can be similar to system 400 of FIG. 4. However, in first portion 500, rIP 502 and BSR 504 can be checkpointed on regular intervals into a checkpoint array 506 that can also be used for dispatch MAP recovery. Along with rIP 502 and BSR 504, a BBQ write pointer ID 508 can be checkpointed. An end address 510, ends/spans BSR tag bits 512, and an instruction-is-taken-branch bit 514 can reside in a checkpoint queue 516 or any other RETQ structure which has flush read ports.

Resynchronization detection 518 can start a recovery walk 520 from a RETQid 522A of checkpoint queue 516 that corresponds to a nearest checkpoint 522B of checkpoint array 506 and incrementally regenerate the rIP 502 and BSR 504 for sequential instructions by reading the end address 510 and ends/spans BSR tag bits 512 in checkpoint queue 516. For every taken branch encountered in the walk, first portion 500 of the system of FIGS. 5 and 6 can perform look up in a BBQ 602, starting with BBQ write pointer ID 508 read out of checkpoint array 506. During recovery walk 520, first portion 500 of the system can iteratively provide end address 510 and ends/spans BSR tag bits 512 to adders 604 and 606 of second portion 600 of the system, respectively. Second portion 600 of the system can also provide rIP 608 and BSR tag 610 information looked up in BBQ 602 to adders 604 and 606, respectively. Adders 604 and 606 can respectively be configured to increment recursively rIP 608 and BSR tag 610 based on the end address 510 and ends/spans BSR tag bits 512 until recovery walk 520 reaches a resynchronization pointer 524, at which point the outputs of adders 604 and 606 can respectively correspond to a regenerated rIP 612 and a regenerated BSR 614.

At the end of recovery walk 520, the system of FIGS. 5 and 6 can signal a speculative resynchronization and drive regenerated rIP 612 and regenerated BSR 614 through a redirect bus to a front end of the machine. In the event that the resynchronization becomes nonspeculative during recovery walk 520, the system can kill recovery walk 520. Similarly, the system can kill recovery walk 520 on an older flush (e.g., an older branch redirect or an older speculative resynchronization). As recovery walk 520 is exactly of the same length as a recovery walk for a dispatch MAP, the system of FIGS. 5 and 6, or another system, can recover the dispatch MAP in parallel by stalling dispatch upon resynchronization detection 518 rather than starting another recovery walk for the dispatch MAP after signaling of the speculative resynchronization.

As set forth above, the systems and methods disclosed herein can perform resynchronization at execution time in a less costly manner than other potential techniques. For example, by detecting a resynchronization during an execution time of an instruction, regenerating an instruction pointer in response to the detection, and performing the resynchronization using the regenerated instruction pointer, the disclosed systems and methods can avoid delay with reduced consumption of system resources compared to other potential techniques. For example, the disclosed systems and methods can avoid sending the information to the scheduler for every operation that may resynchronize, thus reducing messaging traffic and consequent power consumption. Also, the disclosed systems and methods can avoid maintaining a table of the information for every dispatched operation, thus reducing data storage, write operations, consequent power consumption, and additional dispatch stalls that can occur if the table becomes large. Reducing resynchronization penalty in the disclosed manner further can open avenues for more aggressive speculation, such as memory order speculation.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” can generally refer to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computing device, comprising:
resynchronization detection circuitry configured to detect, during an execution time of an instruction, a resynchronization;
pointer regeneration circuitry configured to regenerate, in response to the detection, an instruction pointer; and
resynchronization circuitry configured to perform, during the execution time of the instruction, the resynchronization by using the regenerated instruction pointer.

2. The computing device of claim 1, wherein the pointer regeneration circuitry is configured to regenerate the instruction pointer at least in part by walking a retire queue while incrementally regenerating the instruction pointer and a branch shift register identification tag for the instruction.

3. The computing device of claim 2, wherein:
the pointer regeneration circuitry is configured to walk the retire queue at least in part by walking the retire queue between a last taken branch and a resynchronization pointer while incrementally regenerating the instruction pointer and the branch shift register identification tag using an end address of the instruction and one or more delta bits that track the branch shift register identification tag; and
the resynchronization circuitry is configured to perform the resynchronization at an end of a walk of the retire queue by signaling, a speculative resynchronization and driving the regenerated instruction pointer through a redirect bus to a front end.

4. The computing device of claim 3, wherein the pointer regeneration circuitry is configured to start a walk of the retire queue by reading, from a branch buffer queue of the retire queue, the instruction pointer and the branch shift register identification tag of a youngest taken branch older than the instruction.

5. The computing device of claim 3, wherein the pointer regeneration circuitry is configured to start a walk of the retire queue by:
detecting that a branch buffer queue of the retire queue is empty; and
using a retired instruction pointer and branch shift register identification tag in response to the detection that the branch buffer queue is empty.

6. The computing device of claim 2, wherein:
the pointer regeneration circuitry is configured to walk the retire queue at least in part by walking the retire queue between a nearest checkpoint and a resynchronization pointer while incrementally regenerating the instruction pointer and the branch shift register identification tag for sequential instructions using an end address of the instruction and one or more delta bits that track the branch shift register identification tag in a checkpoint queue of the retire queue and, for each taken branch encountered during a walk of the retire queue, performing a lookup, starting with a branch buffer queue identity read from a checkpoint array, of a branch buffer queue of the retire queue; and
the resynchronization circuitry is configured to perform the resynchronization at an end of a walk of the retire queue by signaling a speculative resynchronization and driving the regenerated instruction pointer through a redirect bus to a front end.

7. The computing device of claim 6, further comprising:
dispatch map recovery circuitry configured to stall dispatch in response to the detection of the resynchronization and perform a recovery walk for a dispatch map in parallel with the walk of the retire queue.

8. A system comprising:
at least one physical processor; and
physical memory comprising computer-executable instructions that, when executed by the physical processor, cause the physical processor to:
detect, during an execution time of an instruction, a resynchronization;
regenerate, in response to the detection, an instruction pointer; and
perform, during the execution time of the instruction, the resynchronization by using the regenerated instruction pointer.

9. The system of claim 8, wherein the computer-executable instructions cause the physical processor to regenerate the instruction pointer at least in part by walking a retire queue while incrementally regenerating the instruction pointer and a branch shift register identification tag for the instruction.

10. The system of claim 9, wherein the computer-executable instructions cause the physical processor to:
walk the retire queue at least in part by walking the retire queue between a last taken branch and a resynchronization pointer while incrementally regenerating the instruction pointer and the branch shift register identification tag using an end address of the instruction and one or more delta bits that track the branch shift register identification tag; and
perform the resynchronization at an end of a walk of the retire queue by signaling, a speculative resynchronization and driving the regenerated instruction pointer through a redirect bus to a front end.

11. The system of claim 10, wherein the computer-executable instructions cause the physical processor to start a walk of the retire queue by reading, from a branch buffer queue of the retire queue, the instruction pointer and the branch shift register identification tag of a youngest taken branch older than the instruction.

12. The system of claim 10, wherein the computer-executable instructions cause the physical processor to start a walk of the retire queue by:
detecting that a branch buffer queue of the retire queue is empty; and
using a retired instruction pointer and branch shift register identification tag in response to the detection that the branch buffer queue is empty.

13. The system of claim 9, wherein the computer-executable instructions cause the physical processor to:
walk the retire queue at least in part by walking the retire queue between a nearest checkpoint and a resynchronization pointer while incrementally regenerating the instruction pointer and the branch shift register identification tag for sequential instructions using an end address of the instruction and one or more delta bits that track the branch shift register identification tag in a checkpoint queue of the retire queue and, for each taken branch encountered during a walk of the retire queue, performing a lookup, starting with a branch buffer queue identity read from a checkpoint array, of a branch buffer queue of the retire queue; and
perform the resynchronization at an end of a walk of the retire queue by signaling, a speculative resynchronization and driving the regenerated instruction pointer through a redirect bus to a front end.

14. The system of claim 13, wherein the computer-executable instructions further cause the physical processor to stall dispatch in response to the detection of the resynchronization and perform a recovery walk for a dispatch map in parallel with the walk of the retire queue.

15. A computer-implemented method comprising:
detecting, by at least one processor and during an execution time of an instruction, a resynchronization;
regenerating, by the at least one processor and in response to the detection, an instruction pointer; and
performing, by the at least one processor and during the execution time of the instruction, the resynchronization by using the regenerated instruction pointer.

16. The computer-implemented method of claim 15, wherein regenerating the instruction pointer includes walking a retire queue while incrementally regenerating the instruction pointer and a branch shift register identification tag for the instruction.

17. The computer-implemented method of claim 16, wherein:
walking the retire queue includes walking the retire queue between a last taken branch and a resynchronization pointer while incrementally regenerating the instruction pointer and the branch shift register identification tag using an end address of the instruction and one or more delta bits that track the branch shift register identification tag; and
performing the resynchronization occurs at an end of a walk of the retire queue and includes signaling a speculative resynchronization and driving the regenerated instruction pointer through a redirect bus to a front end.

18. The computer-implemented method of claim 17, wherein incrementally regenerating the instruction pointer and the branch shift register identification tag includes starting a walk of the retire queue by reading, from a branch buffer queue of the retire queue, the instruction pointer and the branch shift register identification tag of a youngest taken branch older than the instruction.

19. The computer-implemented method of claim 17, wherein incrementally regenerating the instruction pointer and the branch shift register identification tag includes starting a walk of the retire queue by:
detecting that a branch buffer queue of the retire queue is empty; and
using a retired instruction pointer and branch shift register identification tag in response to the detection that the branch buffer queue is empty.

20. The computer-implemented method of claim 16, wherein:
walking the retire queue includes walking the retire queue between a nearest checkpoint and a resynchronization pointer while incrementally regenerating the instruction pointer and the branch shift register identification tag for sequential instructions using an end address of the instruction and one or more delta bits that track the branch shift register identification tag in a checkpoint queue of the retire queue and, for each taken branch encountered during a walk of the retire queue, performing a lookup, starting with a branch buffer queue identity read from a checkpoint array, of a branch buffer queue of the retire queue; and
performing the resynchronization occurs at an end of a walk of the retire queue and includes signaling a speculative resynchronization and driving the regenerated instruction pointer through a redirect bus to a front end.
